(19) United States
(12) Patent Application Publication
(10) Pub. No.: US 2016/0369690 A1
(43) Pub. Date: Dec. 22, 2016

(54) VOLUME MEASURING STRUCTURE FOR CYLINDER HEAD AND PISTON FOR ENGINE

(71) Applicant: HYUNDAI MOTOR COMPANY, Seoul (KR)

(72) Inventors: Hong Kil BAEK, Seoul (KR); Seung Woo LEE, Seoul (KR); Tae Won LEE, Incheon (KR)

(21) Appl. No.: 14/858,735

(22) Filed: Sep. 18, 2015

(30) Foreign Application Priority Data
Jun. 18, 2015 (KR) 10-2015-0086448

(51) Int. Cl. F02B 77/08; G01F 17/00; F02P 13/00; F02F 1/24; F02F 1/42

(52) U.S. Cl. CPC F02B 77/085; F02F 1/242; F02F 1/42; F02P 13/00; G01F 17/00

(57) ABSTRACT

A volume measuring structure of a cylinder head and a piston for an engine includes: a cylinder block configured to form a frame of an engine and include a cylinder in which a piston reciprocates to generate power; a cylinder head configured to be mounted on the cylinder block to form a combustion chamber along with the cylinder and include an ignition plug which ignites the engine and a valve which opens and closes intake and exhaust passages; a first pressure sensor configured to be mounted in the cylinder block to determine a volume of the cylinder block; and a second pressure sensor configured to be mounted in the cylinder head to determine a volume of the cylinder head.

### CROSS-REFERENCE TO RELATED APPLICATION

This application is based on and claims the benefit of priority to Korean Patent Application No. 10-2015-0086448, filed on Jun. 18, 2015 in the Korean Intellectual Property Office, the disclosure of which is incorporated herein in its entirety by reference.

### TECHNICAL FIELD

The present disclosure relates to a volume measuring structure for a cylinder head and a piston for an engine, and more particularly, to a volume measuring structure for a cylinder head and a piston for an engine capable of improving volume measuring accuracy and reducing volume deviations and compression ratio deviations using a pressure sensor while measuring volumes of the piston and the cylinder head.

### BACKGROUND

Generally, a compression ratio of an engine is an important variable to determine overall engine efficiency to a volume of a combustion chamber at the time of compression.

When the compression ratio is set to be high, the engine needs to have good fuel efficiency and power in both of a partial load and a full load. However, the engine has good fuel efficiency at the partial load but the engine has more reduced power than the low compression ratio at the full load due to a knock.

Therefore, the volume of the combustion chamber is set by appropriately designing the compression ratio.

Further, even though the compression ratio is calculated based on a design, the volume of the combustion chamber may not be obtained as designed when the cylinder head is machined depending on the actual casting specification, and therefore the volume of the combustion chamber is measured by actual measurement and the measured volume is inversely operated to the compression ratio.

In this case, when the design value of the compression ratio is 10 but the compression ratio is 11 due to manufacturing errors, the engine may be damaged due to the occurrence of knocking when the engine is deployed.

Further, the related art puts fluids such as water and oil in the cylinder head and the cylinder block and calculates the amount of input fluid to calculate the volume and the compression ratio of the combustion chamber. However, the related art cannot precisely measure the volume and the compression ratio of the combustion chamber, because the calculated amount of the fluids may be changed. A slight error of the volume of the combustion chamber has a great effect on the compression ratio.

### RELATED ART DOCUMENT

Patent 1: Korean Patent Laid-Open Publication No. 10-2004-0031192

### SUMMARY

The present disclosure has been made to solve the above-mentioned problems occurring in the prior art while advantages achieved by the prior art are maintained intact.

An aspect of the present disclosure provides a volume measuring structure for a cylinder head and a piston of a cylinder block for an engine, and more particularly, to improving volume measuring accuracy and reducing volume deviations and compression ratio deviations using a pressure sensor while measuring volumes of a cylinder head and a piston.

According to an exemplary embodiment of the present disclosure, a volume measuring structure of a cylinder head and a piston for an engine includes: a piston configured to be mounted in a cylinder block forming a frame of the engine and and generate power in the cylinder inside the cylinder block; a cylinder head configured to be mounted on the cylinder block to form a combustion chamber along with the cylinder and include an ignition plug which ignites the engine and a valve which opens and closes intake and exhaust passages; a first pressure sensor configured to be mounted in the piston to determine a volume of the piston; and a second pressure sensor configured to be mounted in the cylinder head to determine a volume of the cylinder head.

The first pressure sensor may be mounted in the piston and may be positioned to be close to a flat side of the cylinder head.

The second pressure sensor may be mounted in the ignition plug of the cylinder head and may be positioned to be close to a flat side of the cylinder block.

The first pressure sensor and the second pressure sensor may interwork with a controller to reduce volume deviations and compression ratio deviations of the piston and the cylinder head based on the volumes determined by the first pressure sensor and the second pressure sensor.

According to another exemplary embodiment of the present disclosure, a volume measuring structure of a cylinder head and a piston for an engine includes: a piston configured to be mounted in a cylinder block forming a frame of the engine and generate power in the cylinder inside the cylinder block; a cylinder head configured to be mounted on the cylinder block to form a combustion chamber along with the cylinder and include an ignition plug which ignites the engine and a valve which opens and closes intake and exhaust passages; a first pressure sensor configured to be mounted in the piston and to be positioned to be close to a flat side of the cylinder head to determine a volume of the piston; a second pressure sensor configured to be mounted in an ignition plug of the cylinder head and to be positioned to be close to a flat side of the cylinder block to determine a volume of the cylinder head; and a controller configured to interwork with the first pressure sensor and the second pressure sensor to reduce volume deviations and compression ratio deviations of the piston and the cylinder head based on the volumes determined by the first pressure sensor and the second pressure sensor.

### BRIEF DESCRIPTION OF THE DRAWINGS

The above and other objects, features and advantages of the present disclosure will be more apparent from the following detailed description taken in conjunction with the accompanying drawings.

FIG. 1 is a diagram illustrating a piston of a cylinder block in a volume measuring structure for a cylinder head and a piston for an engine according to an exemplary embodiment of the present disclosure; and

FIG. 2 is a diagram illustrating a cylinder head in the volume measuring structure for a cylinder head and a piston for an engine according to the exemplary embodiment of the present disclosure.

### DETAILED DESCRIPTION

Hereinafter, exemplary embodiments of the present disclosure will be described with reference to the accompanying drawings.

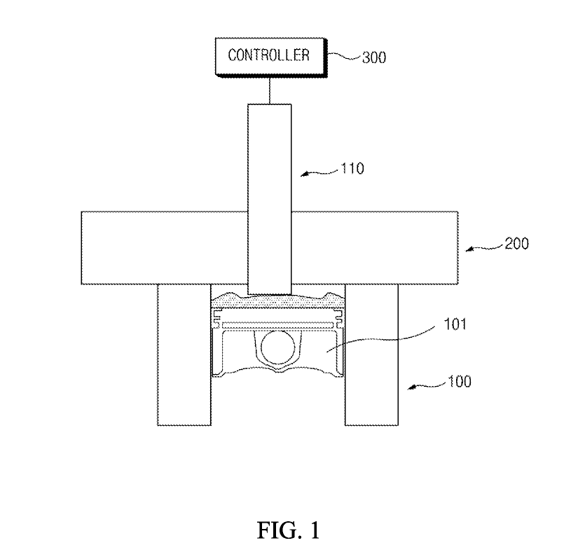

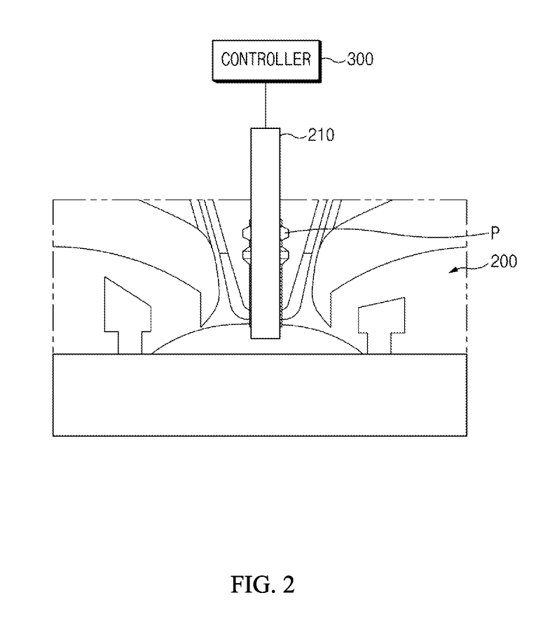

As illustrated in FIGS. 1 and 2, a volume measuring structure for a cylinder head and a piston for an engine according to an exemplary embodiment of the present disclosure includes a piston 101 included in a cylinder block 100, a cylinder head 200 mounted on the cylinder block 100, a first pressure sensor 110 included in the piston 101, and a second pressure sensor 210 included in the cylinder head 200.

The cylinder block 100 forms a frame of an engine.

An inside of the cylinder block 100 is provided with a cylinder and an inside of the cylinder is provided with the piston 101 to generate power.

As illustrated in FIG. 1, the piston 101 is provided with the first pressure sensor 101 to measure the pressure inside the piston 101 so as to determine the volume of the piston 101.

Further, the first pressure sensor 110 is mounted in the piston 101 and is positioned to be close to a flat side of the cylinder head 200, thereby improving the volume measuring accuracy of the piston 101.

The cylinder head 200 is mounted on the cylinder block 100 to form the combustion chamber along with the cylinder.

The cylinder head 200 includes an ignition plug P which ignites the engine and a valve which opens and closes intake and exhaust passages.

In this case, as illustrated in FIG. 2, the cylinder head 200 is provided with the second pressure sensor 210 to measure the pressure inside the cylinder head so as to determine the volume of the cylinder head 200.

Further, the second pressure sensor 210 is mounted in the ignition plug P of the cylinder head 200 and is positioned to be close to a flat side of the cylinder block 100, thereby improving the volume measuring accuracy of the cylinder head 200.

Meanwhile, the first pressure sensor 110 and the second pressure sensor 210 interwork with a controller 300 additionally provided to reduce volume deviations and compression ratio deviations of the piston 101 and the cylinder head 200 based on the volumes determined by the first pressure sensor 110 and the second pressure sensor 210.

In this case, the volume of the piston 101 and the volume of the cylinder head 200 may be divided into a grade by the controller 300, in which the volume of the piston 101 is divided into six grades by the controller 300 (grade a: +0.3 to +0.2, grade b: +0.2 to +0.1, grade c: +0.1 to +0.0, grade d: 0.0 to −0.1, grade e: −0.1 to −0.2, grade f: −0.2 to −0.3) by 0.1 between −0.3 and +0.3 and the volume of the cylinder head 200 is divided into eight grades (grade A: +0.4 to +0.3, grade B: +0.3 to +0.2, grade C: +0.2 to +0.1, grade D: +0.1 to 0.0, grade D: 0.0 to −0.1, grade F: −0.1 to −0.2, grade G: −0.2 to −0.3, grade H: −0.3 to −0.4) by 0.1 between −0.4 and +0.4.

That is, the volume of the piston 101 is divided into six grades and thus the volume deviation may be minimized up to 0.05 cc and the volume of the cylinder head 100 is divided into eight grades and thus the volume deviation may be minimized up to 0.05 cc, such that the compression ratio deviation may be minimized from 0.05 to 0.1.

As such, the volume measuring structure according to the exemplary embodiment of the present disclosure includes the piston 101 which forms a frame of the engine and generates power in the cylinder inside the cylinder block 100, the cylinder head 200 which is mounted on the cylinder block 100 to form the combustion chamber along with the cylinder and includes the ignition plug P igniting the engine and the valve opening and closing the intake and exhaust passages, the first pressure sensor 110 which is mounted in the piston 101 to determine the volume of the piston 101, and the second pressure sensor 210 which is mounted in the cylinder head 200 to determine the volume of the cylinder head 200. By this configuration, the volumes of the piston 101 and the cylinder head 200 may be determined by the pressure sensors to improve the measurement accuracy and to reduce the volume deviations and the compression ratio deviations, thereby improving the fuel efficiency and to secure the knocking robustness, thereby increasing the marketability of the engine.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A volume measuring structure of a cylinder head and a piston for an engine, comprising:
a piston configured to be mounted in a cylinder block forming a frame of the engine and generate power in the cylinder inside the cylinder block;
a cylinder head configured to be mounted on the cylinder block to form a combustion chamber along with the cylinder and include an ignition plug which ignites the engine and a valve which opens and closes intake and exhaust passages;
a first pressure sensor configured to be mounted in the piston to determine a volume of the piston; and
a second pressure sensor configured to be mounted in the cylinder head to determine a volume of the cylinder head.

2. The volume measuring structure of claim 1, wherein the first pressure sensor is mounted in the piston and is positioned to be close to a flat side of the cylinder head.

3. The volume measuring structure of claim 1, wherein the second pressure sensor is mounted in the ignition plug of the cylinder head and is positioned to be close to a flat side of the cylinder block.

4. The volume measuring structure of claim 1, wherein the first pressure sensor and the second pressure sensor interwork with a controller to reduce volume deviations and compression ratio deviations of the piston and the cylinder head based on the volumes measured by the first pressure sensor and the second pressure sensor.

5. A volume measuring structure of a cylinder head and a piston for an engine, comprising:
a piston configured to be mounted in a cylinder block forming a frame of the engine and generate power in the cylinder inside the cylinder block;
a cylinder head configured to be mounted on the cylinder block to form a combustion chamber along with the cylinder and include an ignition plug which ignites the engine and a valve which opens and closes intake and exhaust passages;
a first pressure sensor configured to be mounted in the piston and to be positioned to be close to a flat side of the cylinder head to measure a volume of the piston;
a second pressure sensor configured to be mounted in an ignition plug of the cylinder head and to be positioned to be close to a flat side of the cylinder block to measure a volume of the cylinder head; and
a controller configured to interwork with the first pressure sensor and the second pressure sensor to reduce volume deviations and compression ratio deviations of the piston and the cylinder head based on the volumes determined by the first pressure sensor and the second pressure sensor.
